(19) United States
(12) Patent Application Publication
(10) Pub. No.: US 2015/0172766 A1
(43) Pub. Date: Jun. 18, 2015

(54) IMAGE DISPLAY APPARATUS, METHOD FOR DRIVING IMAGE DISPLAY APPARATUS, METHOD FOR DISPLAYING AN IMAGE, AND COMPUTER READABLE RECORDING MEDIUM THEREFOR

(71) Applicant: SAMSUNG ELECTRONICS CO., LTD., Suwon-si (KR)

(72) Inventors: Sun-hwa SHIN, Suwon-si (KR); Thach Ba NGUYEN, Suwon-si (KR)

(73) Assignee: SAMSUNG ELECTRONICS CO., LTD., Suwon-si (KR)

(21) Appl. No.: 14/334,891

(22) Filed: Jul. 18, 2014

(30) Foreign Application Priority Data
Dec. 12, 2013 (KR) 10-2013-0154943

(51) Int. Cl. H04N 21/472; G10L 15/26; H04N 21/422; G06F 3/16

(52) U.S. Cl. CPC H04N 21/472; G06F 3/167; G10L 15/26; H04N 21/42204

(57) ABSTRACT

An image display apparatus is provided. The image display apparatus includes a display configured to display a plurality of contents on a plurality of screens, a user interface configured to receive a command for selecting a screen from among the plurality of screens, a sound outputter configured to output a sound, and a controller configured to control the sound outputter to output a voice of a content displayed on the selected screen, and control the display to display voice information related to at least one content among the plurality of contents, the at least one content being displayed on at least one screen among the plurality of screens.

### CROSS-REFERENCE TO RELATED APPLICATION

This application claims priority under 35 U.S.C. §119 from Korean Patent Application No. 10-2013-0154943, filed on Dec. 12, 2013, in the Korean Intellectual Property Office, the disclosure of which is incorporated herein by reference in its entirety.

### BACKGROUND

1. Field

Apparatuses and methods consistent with exemplary embodiments relate to an image display apparatus, a method for driving the image display apparatus, a method for displaying an image, and a computer readable recording medium therefor, and more particularly, to an image display apparatus which is capable of providing a screen where a multi-view function for a plurality of contents is available, outputting a voice corresponding to a content selected by a user, and displaying voice information of other contents on a display screen, a method for driving an image display apparatus, a method for displaying an image, and a computer readable recording medium therefor.

2. Description of the Related Art

A multi-window function refers to a function of dividing a screen into a plurality of windows and displaying a plurality of different information on the plurality of windows. The multi-window function may be used to provide a plurality of images on a display by modeling a state where a plurality of documents are on a table in, for example, an office environment.

For example, when the multi-window function is applied to a television (TV), a user may select a voice source to be outputted to a TV speaker. The user may select to receive only a single voice data at a time even when the user watches multiple screens at the same time. In addition, when the user wishes to obtain voice information of another screen, the user needs to select the another screen and set the another screen to output a voice. In a common multi-window environment, a user needs to select a source regarding desired voice information since a TV has only a speaker to output voice information.

Thus, a user in the multi-window environment needs to select each of corresponding screens one by one to output voice information of a desired channel. In addition, a user may have a diversified need for a product, and thus a user-customized service is desirable to increase a product demand.

### SUMMARY

One or more exemplary embodiments provide an image display apparatus which is capable of providing a screen where a multi-view function for a plurality of contents is available, outputting a voice corresponding to a content selected by a user, and displaying voice information of other contents on a display screen, a method for driving an image display apparatus, a method for displaying an image, and a computer readable recording medium therefor.

According to an aspect of an exemplary embodiment, provided is an image display apparatus including: a display configured to display a plurality of contents on a plurality of screens, a user interface configured to receive a command for selecting a screen from among the plurality of screens, a sound outputter configured to output a sound, and a controller configured to control the sound outputter to output a voice of a content displayed on the selected screen, and control the display to display voice information related to at least one content among the plurality of contents, the at least one content being displayed on at least one screen among the plurality of screens.

The at least one screen where the voice information is displayed may be at least one of the screens other than the selected screen.

The apparatus may include a signal receiver configured to receive an image signal corresponding to each of the plurality of contents, a signal divider configured to divide the received image signal into a video signal, an audio signal, and additional information having voice information, a decoder configured to decode the video signal and the audio signal, a storage configured to store the additional information, a video processor configured to scale the decoded video signal, add the additional information to the scaled video signal, and transmit the video signal added with the additional information to the display, and the audio processor configured to scale and transmit the decoded audio signal to the sound outputter.

The signal receiver may include a first receiver configured to receive an image signal corresponding to a content, the content comprising a broadcast signal, a second receiver configured to receive an image signal corresponding to a content, the content not comprising the broadcast signal, and a switching unit configured to select at least one from among the first receiver and the second receiver.

The first receiver may include at least one tuner configured to tune at least one channel of the broadcast signal, and the second receiver may include a plurality of input terminals configured to receive an image signal different from the broadcast signal.

The apparatus may further include a graphic user interface (GUI) generator configured to generate a menu screen for displaying contents on the display to be selectable by a user, and when the additional information having voice information does not exist in a selected content, generate and transmit a message notifying nonexistence of the additional information in the selected content to the display. In addition, the switching unit may have a selection route which is controlled based on the selected content.

When the additional information does not exist in the selected content, the GUI generator may additionally generate a message inquiring whether to replace the content with another content having the additional information. In addition, when the user instructs to replace the content with the another content, the controller may control the display to display the another content.

The controller may search the another content having the additional information.

The apparatus may further include a storage configured to store history information on contents selected by the user. In addition, the controller may search the another content based on the history information.

The apparatus may further include a voice transcriber configured to, when the additional information having voice information does not exist in the received image signal, analyze and transcribe a voice of a content corresponding to the received image signal. In addition, the controller may display characters generated according to a result of the analysis and transcription on the display.

According to an aspect of another exemplary embodiment, provided is a method for driving an image display apparatus including: displaying a plurality of contents on a plurality of screens trough a display, receiving a command for selecting a screen from among the plurality of screens, outputting a voice of a content displayed on the selected screen, and controlling the display to display voice information related to at least one content on at least one screen among the plurality of screens.

The at least one screen where the voice information is displayed may be at least one of the plurality of screens other than the selected screen.

The method may further include receiving an image signal corresponding to each of the plurality of contents, dividing the received image signal into a video signal, an audio signal, and additional information having voice information, decoding the video signal and the audio signal, storing the additional information, scaling the decoded video signal, adding the additional information to the scaled video signal, and transmitting the video signal added with the information to the display, and scaling and transmitting the decoded audio signal to be output.

The receiving the image signal may include receiving, via a first route, an image signal corresponding to a content, the content comprising a broadcast signal, receiving, via a second route, an image signal corresponding to a content, the content not comprising the broadcast signal, and selecting at least one route from among the first route and the second route.

The receiving the image signal corresponding to a content, the content comprising a broadcast signal, may include tuning at least one channel of the broadcast channel. In addition, the receiving image signal corresponding to a content, the content not comprising the broadcast signal, may include receiving an image signal different from the broadcast signal through a plurality of input terminals.

The method may further include generating a menu screen for displaying content on the display to be selectable by a user, and when the additional information having voice information does not exist in a selected content, generating and transmitting a message notifying nonexistence of the additional information in the selected content to the display. In addition, the controlling may include controlling to select a route screen based on the selected content.

The method may further include, when additional information does not exist in the selected content, generating a message inquiring whether to replace the content with another content having the additional information. In addition, when a user instructs to replace the content with the another content, the controlling may include controlling the display to display the another content.

The controlling may include searching the another content having the additional information.

The method may further include storing history information on contents selected by the user. In addition, the searching may include searching the another content based on the history information.

The method may further include, when the additional information having voice information does not exist in the received image signal, analyzing and transcribing a voice of a content corresponding to the received image signal. In addition, the controlling may include displaying characters generated according to a result of the analysis and transcription on the display.

According to an aspect of still another exemplary embodiment, provided is a method for displaying an image including: displaying a plurality of contents on a plurality of screens on a display, displaying voice information related to at least one content among the plurality of contents, the at least one content being displayed on at least one screen other than a screen selected to output a voice from among the plurality of screens, and when voice information related to the at least one content does not exist, replacing the at least one content with another content having the voice information and displaying the another content.

The method may further include, when the voice information related to the at least one content does not exist, displaying a message notifying nonexistence of the voice information related to the at least one content.

According to an aspect of still another exemplary embodiment, provided is a computer readable recording medium for executing a method for displaying an image, the method including: displaying a plurality of contents on a plurality of screens, displaying voice information related to at least one content on at least one screen other than a screen selected, from among the plurality of screens, to output a voice therefrom, and when the voice information related to the at least one content does not exist, replacing the at least one content with another content having the voice information and displaying the another content.

### BRIEF DESCRIPTION OF THE DRAWINGS

The above and/or other aspects will be more apparent by describing certain exemplary embodiments with reference to the accompanying drawings, in which:

FIG. 1 is a diagram illustrating an image display system according to an exemplary embodiment;

FIG. 2 is a diagram illustrating an example of a screen of an image display apparatus according to an exemplary embodiment;

FIGS. 3A to 3B are diagrams illustrating examples of a screen configuration of the image display apparatus of FIG. 1;

FIG. 4 is a diagram illustrating a state where a message notifying that a divided screen of the image display apparatus of FIG. 1 does not include caption information;

FIG. 5 is a block diagram illustrating a detailed configuration of an image display apparatus of according to an exemplary embodiment;

FIG. 6 is a block diagram illustrating a detailed configuration of an image display apparatus according to another exemplary embodiment;

FIG. 7 is a flowchart illustrating an operation of driving an image display apparatus according to an exemplary embodiment;

FIG. 8 is a flowchart illustrating an operation of driving an image display apparatus according to another exemplary embodiment; and

FIG. 9 is a flowchart illustrating a method for displaying an image according to an exemplary embodiment.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. Thus, it is apparent that exemplary embodiments may be practiced without those specifically defined matters. Also, well-known functions or constructions are not described in detail since they would obscure exemplary embodiments with unnecessary detail.

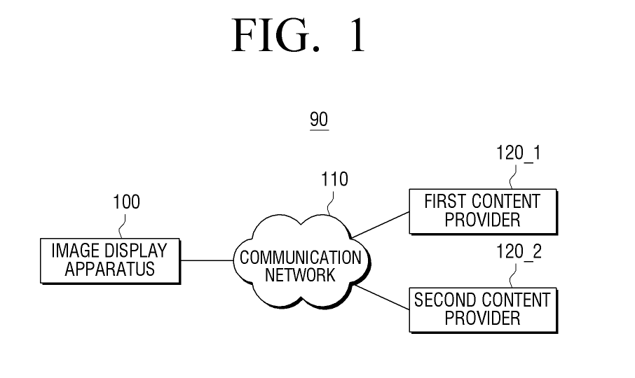

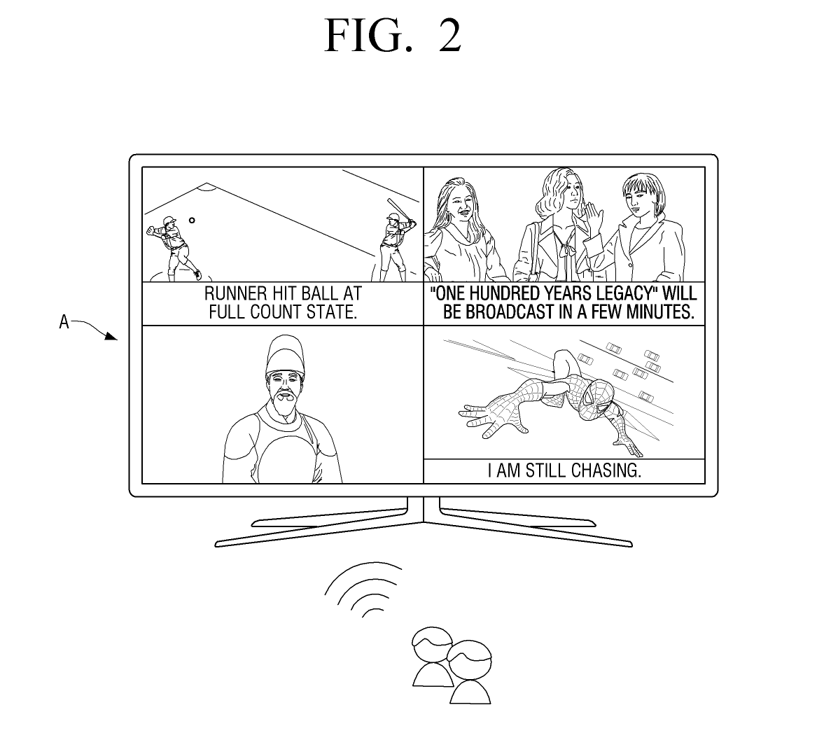

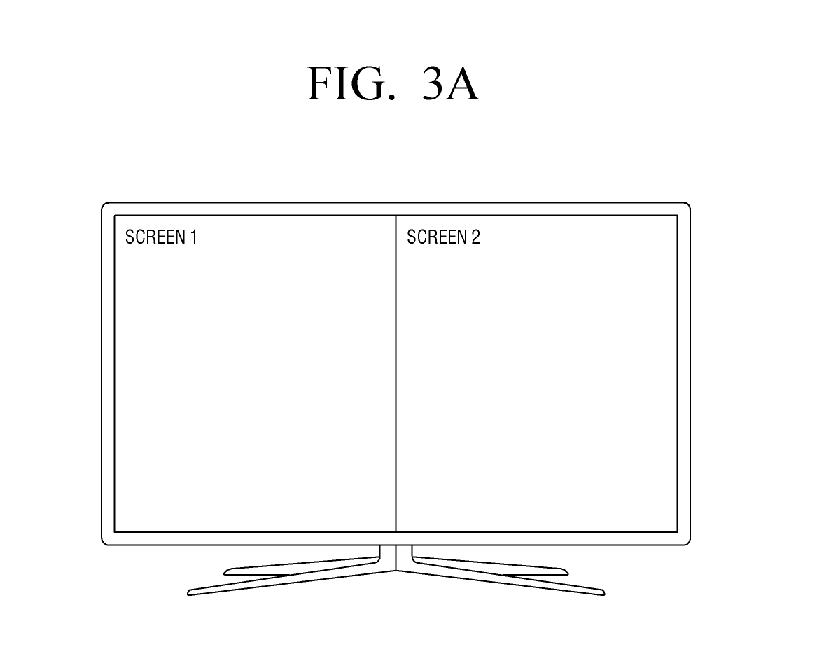

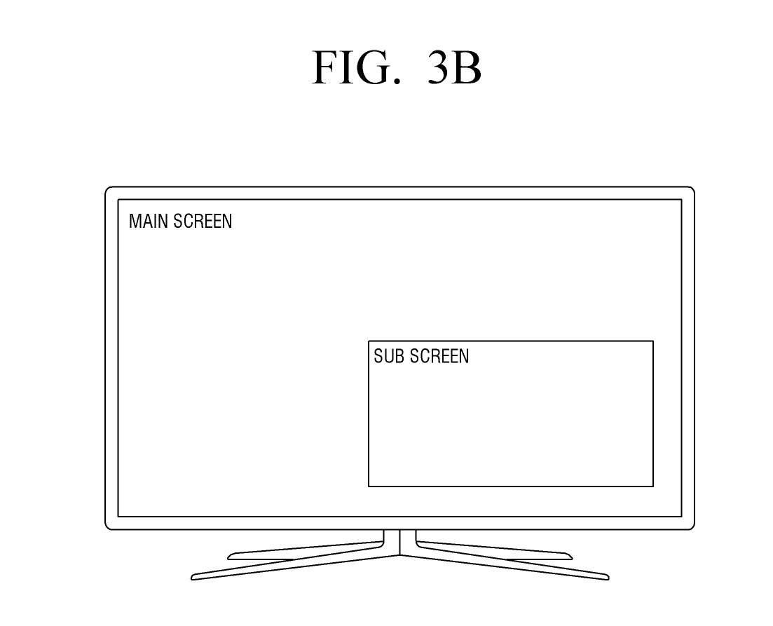

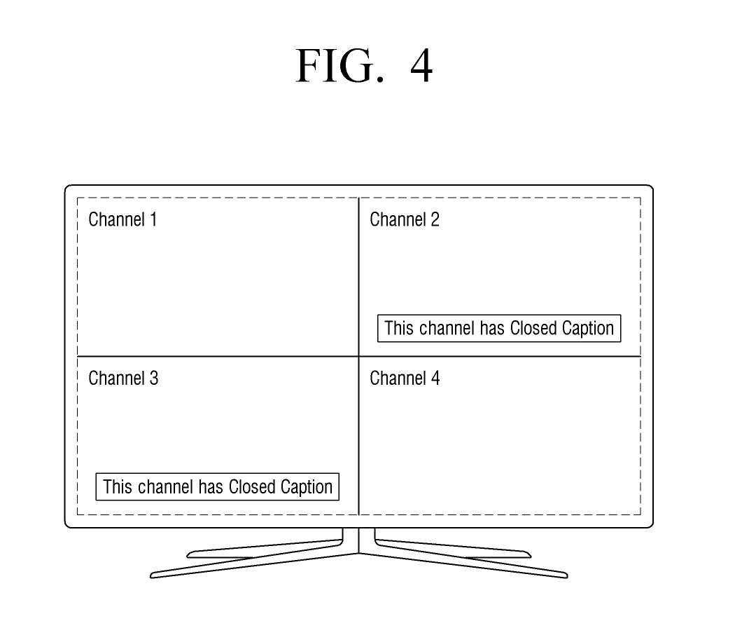

FIG. 1 is a diagram illustrating an image display system according to an exemplary embodiment, and FIG. 2 is a diagram illustrating an example of a screen of an image display apparatus. In addition, FIGS. 3A to 3B are diagrams illustrating examples of a screen configuration of the image display apparatus of FIG. 1, and FIG. 4 is a diagram illustrating a state where a message notifying that a divided screen of the image display apparatus of FIG. 1 does not include caption information.

As illustrated in FIG. 1, an image display system 90 according to an exemplary embodiment includes an image display apparatus 100, a communication network 110, and at least one content provider. For example, the at least one content provider includes a first content provider 120_1 and a second content provider 120_2. The image display system 90 may further include an image relay equipment (not shown) such as a set-top box.

The image display apparatus 100 according to an exemplary embodiment may include a touch screen type image display apparatus, a self-emission display apparatus such as an organic light emitting diode (OLED), or a light receiving display apparatus such as a liquid crystal display (LCD). The image display apparatus 100 may include, but is not limited thereto, a television (TV), a computer, a mobile phone, etc. Herein, the light receiving display apparatus refers to an apparatus having a separate backlight unit which provides a light. In this case, the backlight unit may include a light emitting diode (LED).

The image display apparatus 100 may divide and operate a screen. For example, when a user command for dividing a screen is received, the image display apparatus 100 may divide a screen into four areas as illustrated in FIG. 2, or may divide a screen into two areas as illustrated in FIG. 3A. Further, the image display apparatus 100 may divide a screen in a picture-in-picture (PIP) method and display contents as illustrate in FIG. 3B. Herein, it may be understood that dividing a screen may be performed by a method of substantially equally dividing a screen of the image display apparatus 100 as shown in FIG. 3A, or by the PIP method where two types of data are combined with each other and outputted to divided screens, e.g., a main screen and a sub screen as shown in FIG. 3B.

The divided areas of the screen of the image display apparatus 100 may display contents having substantially the same or similar characteristics such as a broadcast content. In addition, at least a part of the divided areas of the screen may display a broadcast content, and another part of the divided areas may display contents which are inputted through a route different from a route of the broadcast content, e.g., contents provided by an internet provider or YouTube clips, etc. Alternatively, the divided areas of the screen of the image display apparatus 100 may display a high definition multimedia interface (HDMI) image provided by, for example, a video cassette recorder (VCR), a camcorder, a game device, etc.

As illustrated in ‘A’ of FIG. 2, the image display apparatus 100 may receive a selection of a content of which voice (or an audio) a user wishes to hear from among a plurality of contents displayed on the divided areas through an interface with the user. Next, an area where contents other than the selected content are displayed, that is, a display screen of the contents other than the selected content displays voice information thereof. In an exemplary embodiment, voice information of the corresponding contents is transcribed and displayed. Herein, the voice information which is transcribed and displayed may be provided as a caption. In an exemplary embodiment, the caption may include a content of the voice information of the contents, for example, lines in a movie image or a conversation between a newscaster and a sports commentator in a baseball game program, rather than a caption for attracting a user's attention. In addition, when the user changes the content of which voice the user wishes to hear, the image display apparatus 100 outputs a voice of the changed content, and transcribes and displays voice information on display screens where the other contents are displayed.

In an exemplary embodiment, the user may select a desired form of a divided screen, for example, one of forms illustrated in FIGS. 2, 3A, and 3B, through, for example, a menu screen displayed in the image display apparatus 100, and preset information on a preferred channel. For example, the user may set preferred channel information on an hourly basis through a menu screen. For example, the user may set channel information to provide broadcasts of channels numbers 5, 7, 9, and 11 at 7:00 p.m., and set the channel information to provide broadcasts of channel numbers 9 and 11, a particular internet site, and a YouTube clip at 9:00 p.m. The method for setting channel information may be varied. According to an exemplary embodiment, the menu screen may be displayed by being combined or overlapped with a main image, and thus, may be called an on screen display (OSD) screen or a graphic user interface (GUI) screen. Herein, a combined menu screen may refer to a screen which is formed on a same layer as the main image, and an overlapped menu screen may refer to a screen which is formed on a different layer from that of the main screen.

For illustrative purposes, it is assumed that contents are changed according to time and contents and voice information of at least one channel set by the user according to time slots are transcribed and displayed on a certain divided area. When additional information having voice information related to the changed content does not exist, the image display apparatus 100 may provide a message notifying that the corresponding channel does not include the voice information, e.g., caption information, as illustrated in FIG. 4. Further, the image display apparatus 100 may display a message inquiring whether to change a channel in addition to providing the message. When caption information on a content of a certain channel is not provided, the image display apparatus 100 may search and display the caption information of the content through internet. For example, when the second content provider 120_2 is an apparatus which provides a documentary, a movie content, etc., the image display apparatus 100 may receive and display audio data, that is, the caption information through a paring operation with the second content provider 120_2.

In an alternative embodiment, the image display apparatus 100 may not provide the user with a message notifying nonexistence of the voice information. In this case, the image display apparatus 100 may automatically re-search a channel having voice information and replace a content of a current channel with a content provided in the re-searched channel. The re-searching operation may be performed based on information on adjacent channels or information on a preferred channel of the user. For example, the image display apparatus 100 may store a number of times of a channel being selected by the user on an hourly basis, and when it is determined that a particular channel which is set to be provided at a specific time slot, e.g., 9:00 p.m. does not include the caption information, the image display apparatus 100 may re-search a channel having voice information based on information on a channel determined to be selected relatively frequently by the user around 9:00 p.m., and display a content of the searched channel having the voice information.

In a further alternative embodiment, the image display apparatus 100 may analyze an audio signal separated from a received image signal, and display caption information (e.g., characters) according to the analyzed audio signal. For example, the image display apparatus 100 may analyze a pattern of a sound in a corresponding content, and display characters matched with the analyzed pattern of the sound. To this end, the image display apparatus 100 may include a voice transcriber.

In addition, in the above operations, the image display apparatus 100 may interwork with an image relay equipment such as a set-top box.

The communication network 110 may include a wired communication network and/or a wireless communication network. Herein, the wired communication network may include an internet network such as a cable network and a public switched telephone network (PSTN), and the wireless communication network may include code division multiple access (CDMA), wideband CDMA (WCDMA), evolved packet core (EPC), long term evolution (LTE), a wireless broadband (WiBro) network, etc. Accordingly, when the communication network 110 is the wired communication network, an access point may access to a telephone exchange, and when the communication network 110 is the wireless communication network, the access point may process data by accessing to serving general packet radio service (GPRS) support node (SGSN) or gateway GPRS support node (GGSN) which is operated by a communication common carrier or various relay equipments such as a base station transmission (BTS), NodeB, eNodeB, etc.

In addition, the communication network 110 includes an access point (AP) as a femto or pico base station which is commonly provided within a building. Herein, the femto base station and the pico base station are classified according to a maximum number of the image display apparatus 100 to be accessed, under AP classification standards. The AP includes a near field communication module for performing near filed communication such as Zigbee and Wi-Fi with the image display apparatus 100. According to an exemplary embodiment, the near filed communication may be performed by various standards including radio frequency (RF) and ultra wideband (UWB) such as ultra high frequency (UHF) and very high frequency (VHF). Thus, the AP may extract a location of a data packet, designate an optimal communication route corresponding to the extracted location, and transmit the data packet to, for example, the image display apparatus 100 according to the designated communication route.

The first content provider 120_1 may include a server of a broadcasting station and/or a cable station which provides a broadcast signal. The first content provider 120_1 may provide the image display apparatus 100 with a broadcast signal according to a broadcast program. For example, the broadcast program may be scheduled on an hourly basis. In this case, the broadcast signal may include a video signal, an audio signal, and additional information on the broadcast programs on the broadcast program schedule. The additional information may include voice information, which may include caption (or subtitle) information by which an audio or a voice related to the video signal is represented as characters. In some cases, a certain broadcast program may be provided to the image display apparatus 100 without the caption information.

In an exemplary embodiment, the second content provider 120_2 be an apparatus which provides a content (or an image signal) which is different from the broadcast signal. For example, the second content provider 120_2 may be a server of an internet portal company or a company that provides YouTube clips, etc. Alternatively, the second content provider 120_2 may be a server of a company that provides contents such as a movie, a drama episodes, etc. Further, the second content provider 120_2 may provide caption information on a certain content which does not include caption information. For example, it is assumed that a foreign movie which is played back in a Blu-ray disk (BD) player is displayed on a certain divided area. In this case, when caption information, e.g., subtitle information, of a foreign movie content stored in a disk is lost, the second content provider 120_2 may provide the caption information of the foreign movie content in response to a request of the image display apparatus 100.

As described above, an exemplary embodiment may provide a user with a plurality of contents by transcribing and displaying at least one of the plurality of contents under a multi-window environment. In addition, an exemplary embodiment may change a content without caption information based on a user history, and thus, may provide the user with a customized service.

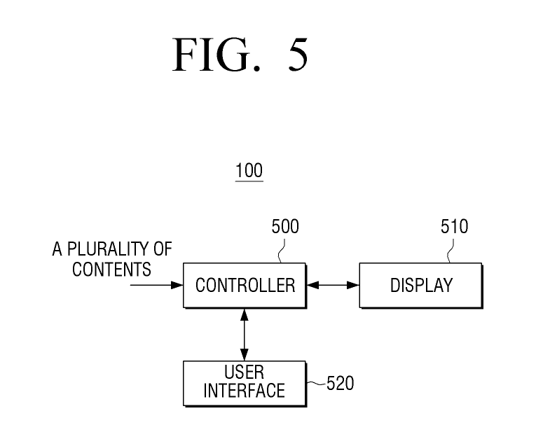

FIG. 5 is a block diagram illustrating a detailed configuration of an image display apparatus according to an exemplary embodiment.

Referring to FIG. 5, the image display apparatus 100 according to an exemplary embodiment may include a controller 500, a display 510, and a part or entire configuration of a user interface 520. Additionally, the image display apparatus 100 may further include a content processor (not shown).

Herein, when the display 510 is a touch panel, a user command may be inputted through the touch panel, and thus, the part or entire configuration of the user interface 520 may be combined with at least a part of the display 510. Herein, it is described that the image display apparatus 100 includes the entire configuration of the user interface 520 for convenience of explanation.

The controller 500 controls an overall operation of elements of the image display apparatus 100, e.g., the display 510 and the user interface 520. For example, the controller 500 divides a display screen of the display 510 and operates the divided display screen according to a user command which is transmitted through the user interface 520. For example, the controller 500 displays a plurality of contents inputted from an external source on the divided display screens of the display 510, respectively, and transcribes and displays voice information on the display screens of contents other than a content of which voice user wishes to be outputted. That is, with respect to the contents other than a content selected by the user, the transcribed voice information replaces an output of a voice thereof. In this case, when it is determined that voice transcription is not possible for a non-selected content, the controller 500 may control the display 510 to analyze an audio signal (or a voice signal) and display characters matched with the analyzed audio signal. Accordingly, the controller 500 may include a voice transcriber (not shown) for analyzing an audio signal and matching characters with the analyzed audio signal. A method of using the voice transcriber is merely an example, and thus, exemplary embodiments are not limited thereto.

Here, the controller 500 may include one or more hardware and/or software components. For example, the controller 500 may include one or more of an integrated circuitry, a dedicated circuit, firmware, and/or a processor such as a central processing unit (CPU) which executes software programs stored in a storage, e.g., a memory.

In an exemplary embodiment, when a request for dividing the display 510 is received from the user, the controller 500 may receive a plurality of contents based on preset information. In this case, the plurality of contents may be broadcast contents or image contents provided by, for example, a plurality of internet portal sites. In addition, the plurality of contents may be received based on information which is inputted by the user when the display 510 is divided. Subsequently, the controller 500 divides contents provided in a form of a broadcast signal, among the received plurality of contents, into a video signal, an audio signal, and additional information, decodes the divided video signal and the audio signal, scales the decoded video signal and audio signal, adds the additional information to the scaled video signal, and provides the display 510 with the scaled video signal with the additional information. In this case, the additional information includes caption information by which a voice related to the video signal is expressed by characters. When the controller 500 receives an image signal in a form of a HDMI signal from a player such as a VCR, the controller 500 may combine and output the additional information with the image signal after performing an operation of scaling the image signal.

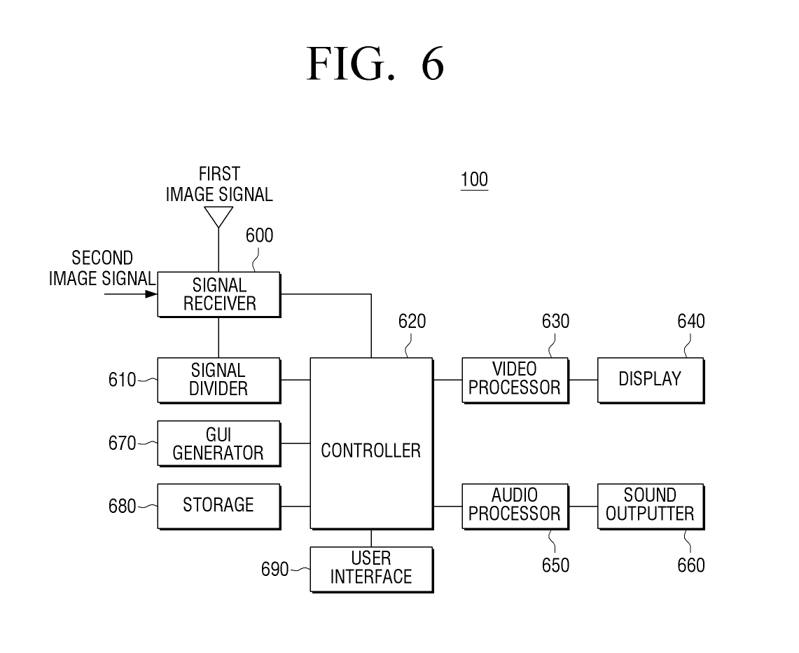

When the image display apparatus 100 includes a content processor (not shown), a signal processing operation as described above may be performed by the content processor, which may be modified according to an intention of a system designer. When the content processor performs the signal processing operation, the controller 500 may store the additional information in a memory, read the stored additional information at a certain point of time, and provide the additional information to be combined with the scaled video signal. The content processor may be different from the controller 500 in that the content processor may select a plurality of contents automatically and sequentially based on a user experience regarding a content, for example, a number of times of selecting a content. For example, when the display screen is divided into four display screens as illustrated in FIG. 2, the content processor may respectively display first to fourth contents in an order of a number of time of being selected. Here, when one of the first to the fourth contents is displayed on one of the four divided display screens but characters related to a voice of the corresponding content are not displayed, the content processor may search and display another content which includes additional information on characters corresponding to voice data thereof in one of the other divided display screens. An operation of the content processor will be described in more detail with reference to FIG. 6, and thus, the detailed description thereof is omitted.

The display 510 may include a display panel. To divide and operate a screen, the display 510 may include a plurality of source drivers for driving a plurality of areas of the screen. For example, when a screen is divided into four areas, the display 510 may include two source drivers corresponding to an upper side of the screen, and may include two source drivers corresponding to a lower side of the screen. When the screen is divided into two areas as illustrated in FIG. 3, the display 510 may operate at least one of the two source drivers on the upper and lower sides on a left side of the screen, and may operate at least one of the two source drivers on the upper and lower sides on a right side of the screen. The source driver may receive data regarding a plurality of data sequentially inputted from the controller 500 and provide the data in parallel to the display panel. The source driver may provide digital information of the received data in a form of an analogue voltage.

The user interface 520 is configured to receive a user command. For example, when the user requests to divide and operate the display screen through a remote control device such as a remote controller, the user interface 520 may receive and transmit the user command to the controller 500. When the user interface 520 processes and transmits various signals provided through an interface with the user to the controller 500, the controller 500 may perform an operation corresponding to the command.

FIG. 6 is a block diagram illustrating a detailed configuration of an image display apparatus according to another exemplary embodiment.

Referring to FIG. 6 in connection with FIG. 1, the image display apparatus 100 according to another exemplary embodiment may include a part or entire configuration of a signal receiver 600, a signal divider 610, a controller 620, a video processor 630, a display 640, an audio processor 650, a sound outputter 660, a GUI generator 670, a storage 680, and a user interface 690.

Herein, it is described that the image display apparatus 100 includes the entire configuration of the aforementioned components for convenience in explanation.

The signal receiver 600 may include a plurality of input terminals. Herein, the plurality of input terminals may include an input terminal (or a first receiver) which receives a first image signal from a broadcasting station, that is, a broadcast signal, and an input terminal (or a second receiver) which is connected to internet or a peripheral device such as a VCR and receives a second image signal therefrom. The plurality of input terminals may include other various forms of input terminals. The signal receiver 600 may include a tuner for tuning the received broadcast signal and a demodulator for demodulating the tuned broadcast signal. Herein, the signal receiver 600 may include a plurality of tuners to receive broadcast signals of a plurality of channels. The demodulator demodulates a modulated broadcast signal.

The signal processor 600 includes a switching unit (e.g., switch) for selecting at least one of a plurality of contents received through the plurality of input terminals according to control of the controller 620. For example, when the user sets channels numbers 5, 7, 9, and 11 to be provided through a menu screen and requests to divide and operate a display screen, the controller 620 controls the switching unit of the signal processor 600 such that the signal receiver 600 may operate a plurality of tuners to receive broadcast signals on the four broadcast channels 5, 7, 9, and 11 selected by the switching unit. In addition, the signal receiver 600 may provide the signal divider 610 with the broadcasts signals of the channels 5, 7, 9, and 11 received through a tuning operation. When the user wishes to watch broadcasts of three channels among the channels 5, 7, 9, and 11 and an internet broadcast, the signal receiver 600 may receive a broadcast signal (e.g., image signal) corresponding to the internet broadcast is received, and thus, may directly transmit the inputted broadcast signal to the controller 620. An HDMI image signal provided from a peripheral device may also be directly transmitted to the controller 620.

The signal divider 610 includes a demultiplexer. That is, the signal divider 610 divides an inputted broadcast signal into a video signal, an audio signal, and additional information and provides the controller 620 with the video and audio signals and the additional information. When the broadcast signal relates to a commercial broadcast, the additional information may include information on a product. Further, in an exemplary embodiment, the additional information may include the caption information (or subtitle) for transcribing and displaying a voice related to contents which are respectively displayed on the divided display screens of the display 640.

The controller 620 may comprise a decoder. The decoder receives a video signal and an audio signal provided from the signal divider 610, decodes the received video and audio signals, and provides the video processor 630 and the audio processor 650 with the decoded video and audio signals, respectively. In this case, the decoding operation is included in an operation of demodulating an encoded broadcast signal. In an exemplary embodiment, a plurality of contents, for example, broadcast signals of a plurality of channels need to be processed, and thus, it is required to be equipped with a plurality of decoders to process each of the broadcast signals. However, exemplary embodiments are not limited thereto. For example, when the image display apparatus 100 includes only a single signal decoder, the signal decoder may decode each of the broadcast signals at a certain time interval.

The controller 620 stores the additional information provided by the signal divider 610 in the storage 680. When the video processor 630 completes processing of a video signal, the controller 620 reads the additional information stored in the storage 680 and provides the video processor 630 with the read additional information. In addition, when a user command is received through the user interface 690, the controller 620 controls various components within the image display apparatus 100 based on the user command. For example, when the user requests to divide and operate a display screen, the controller 620 controls the signal receiver 600 to receive a plurality of image signals. According to an exemplary embodiment, when a user request for dividing and operating a display screen is received, the controller 620 controls the GUI generator 670 to display a menu screen on the display 640. The menu screen may be combined and displayed with a main image which is currently displayed on the display 640 by the video processor 630. When the user selects a desired content through the menu screen, the controller 620 may control the signal receiver 600 based on user selection.

In addition, the controller 620 may determine whether the inputted first image signal and second image signal include the additional information such as the caption information. For example, when a certain video signal and audio signal are provided and the additional information thereof is not provided, the controller 620 determines that the additional information related to the video signal and the audio signal does not exist. In this case, the controller 620 may control the GUI generator 670 to generate a message notifying the nonexistence of the additional information and display the message on a screen of the display 640. Subsequently, when an image signal without the additional information is detected, the controller 620 controls the signal receiver 600 to receive a new image signal having additional information based on a user history stored in the storage 680 or a searching operation with respect to adjacent channels. The searching operation may correspond to a tuning operation in case of a broadcast signal.

Further, as described above, when it is determined that displaying the additional information on the content of a certain channel is not possible, or even when it is possible, the controller 620 may use a voice transcriber included therein to analyze an audio signal which is separated from the inputted image signal (or video signal) and generate characters based on the analysis. The operation of the voice transcriber has been described above, and thus, the detailed description thereof is omitted.

Here, the controller 620 may include one or more hardware and/or software components. For example, the controller 620 may include one or more of an integrated circuitry, a dedicated circuit, firmware, and/or a processor such as a central processing unit (CPU) which executes software programs stored in a storage, e.g., a memory.

The video processor 630 processes a video signal with respect to a plurality of inputted contents. Herein, a processing operation of the video processor 630 may be understood as a scaling operation of a video signal. The scaling operation may refer to bit conversion which converts 8-bit data into 6-bit data, for example. The video processor 630 may include at least one scaler for processing a plurality of video signals according to an exemplary embodiment. In addition, the video processor 630 may further include a mixer for combining the menu screen and/or the message provided by the GUI generator 670 with the main image.

The display 640 may have a configuration substantially the same or similar to that of the display 510 that has been described above with reference to FIG. 5, and thus, the detailed description thereof is omitted.

The audio processor 650 scales an inputted audio signal and outputs the scaled audio signal. Herein, the scaling operation may refer to an operation of reducing or equalizing noise in the inputted audio signal. That is, the scaling operation may refer to an operation of correcting a distorted audio signal. According to an exemplary embodiment, the audio processor 650 may process only an audio signal related to the content of which voice the user wishes to hear.

The sound outputter 660 may include a speaker, but is not limited thereto. For example, and the sound outputter 660 may refer to a load unit line other than the speaker, that is, a connector.

The GUI generator 670 may generate a menu screen or provide a pre-generated menu screen according to a request of the controller 620. Also, when it is determined that additional information of the inputted image signal (or video signal) does not exist, the GUI generator 670 may generate a message notifying the nonexistence of the additional information. In addition, when the additional information does not exist, the GUI generator 670 may additionally generate and provide the user with a message inquiring whether to replace content of the inputted image signal (or video signal) with another content having the additional information and display the another content. The menu screen may be provided in various forms. For example, a menu screen which allows the user to select a desired content or image signal on an hourly basis may be provided.

The storage 680 may temporarily store the additional information provided by the controller 620, and output the stored additional information in response to a request of the controller 620. In addition, the storage 280 stores information on a channel and a broadcast program selected by the user based on the user history. Herein, the user history may include information on a number of times of a channel and a broadcast program being selected by the user and/or provided to the user.

The user interface 690 may have a configuration substantially the same or similar to that of the user interface 520 that has been described in detail with reference to FIG. 5, and thus, the detailed description thereof is omitted.

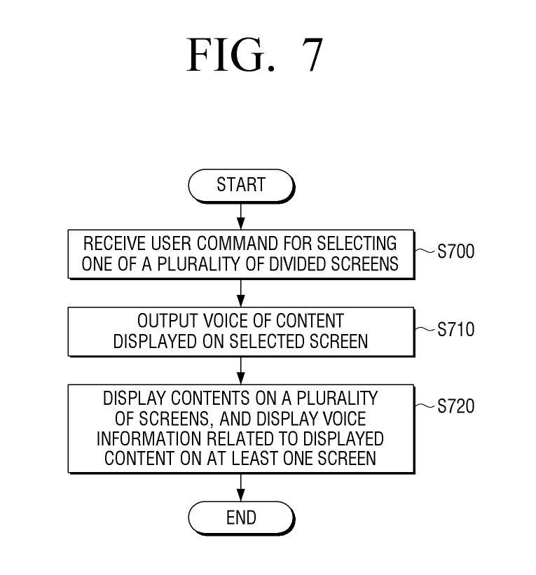

FIG. 7 is a flowchart illustrating an operation of driving an image display apparatus according to an exemplary embodiment.

For convenience in explanation, it is assumed that the operation of FIG. 7 is performed by the image display apparatus 100 according to the exemplary embodiment of FIG. 1. Referring to FIG. 7, the image display apparatus 100 according to an exemplary embodiment divides a screen to display a plurality of contents on a plurality of divided screens, and receives a user command for selecting at least one of the plurality of divided screens (S700). The user command may be received through an interface with the user. For example, the interface with the user may be performed by a remote controller manipulated by the user, or when the image display apparatus 100 includes a touch panel, may be performed by the touch panel.

In addition, the image display apparatus 100 outputs a voice of a content which is displayed on the selected divided screen (S710).

The display of the image display apparatus 100 displays contents on the plurality of divided screens, and displays voice information of a displayed content on at least one divided screen (S720). That is, the display transcribes and displays a voice of the displayed content on at least one divided screen. In an exemplary embodiment, display screens of contents other than the content which is selected to output the voice display characters corresponding to the voice information, but exemplary embodiments are not limited thereto. For example, only one from among the divided display screens where non-selected contents are displayed may display the characters.

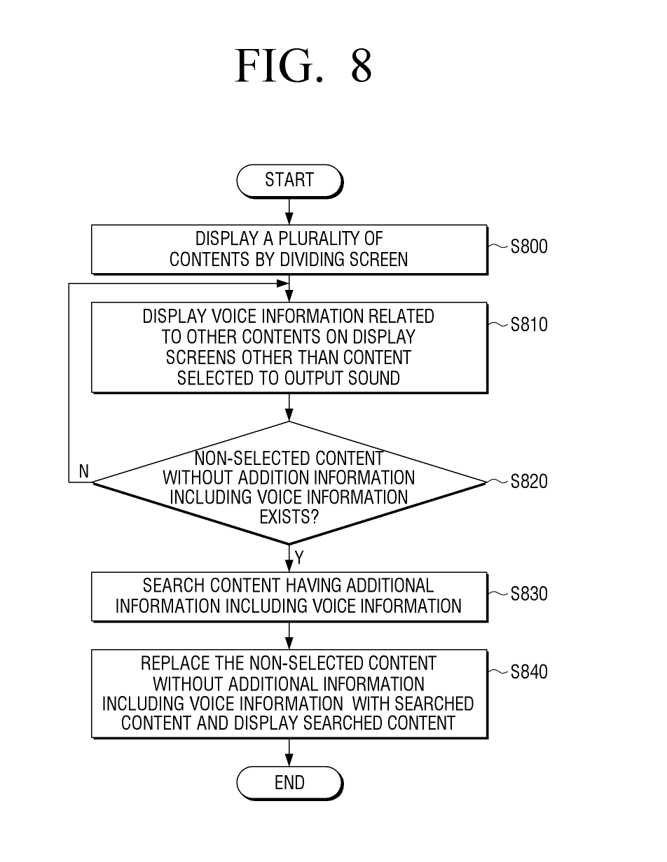

FIG. 8 is a flowchart illustrating an operation of driving an image display apparatus according to another exemplary embodiment.

For convenience in explanation, it is assumed that the operation of FIG. 8 is performed by the image display apparatus 100 according to the exemplary embodiment of FIG. 1. Referring to FIG. 8, the image display apparatus 100 according to an exemplary embodiment divides a screen and displays a plurality of contents on a plurality of divided screens, respectively, in response to a user request (S800).

Subsequently, the image display apparatus 100 displays voice information related to contents on the plurality of divided display screens other than the content which is selected by the user to output a voice therein (S810). For example, the image display apparatus 100 may transcribe and display the voice.

In the above operations, the image display apparatus 100 determines whether a non-selected content without additional information including voice information exists (S820). For example, when a certain image signal is received and a video signal and an audio signal of the image signal are provided, but additional information of the image signal is not provided, the image display apparatus 100 may determine that the image signal does not have the additional information.

When it is determined that the additional information of the non-selected content exists, the image display apparatus 100 displays the voice information of the non-selected content using the additional information (S810). On the other hand, when it is determined that the additional information of the non-selected content does not exist, the image display apparatus 100 searches (or retrieves) another content having the additional information (S830). In an exemplary embodiment, when the selected content is a content related to a broadcast program provided from a certain channel of a broadcast signal, the image display apparatus 100 may search adjacent channels of the certain channel. Alternatively, when the user history exists, the image display apparatus 100 may search another content having the additional information based on the user history.

When another content having the additional information including the voice information is searched, the image display apparatus 100 replaces the non-selected content without the additional information with the searched content and displays the searched content (S840).

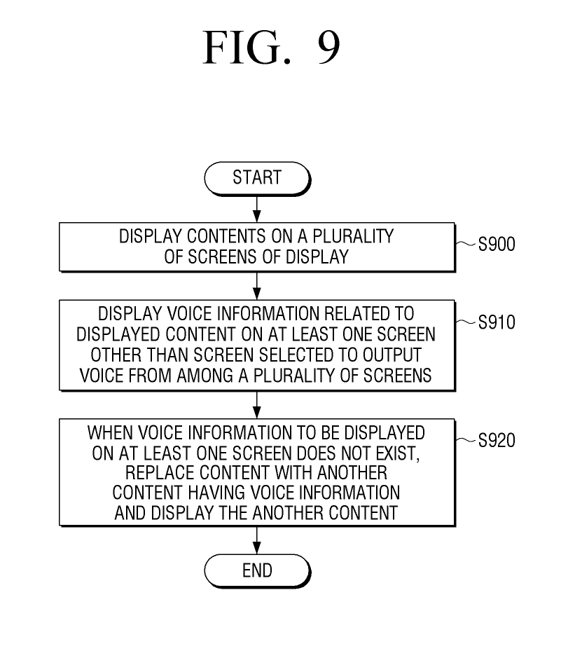

FIG. 9 is a flowchart illustrating a method for displaying an image according to an exemplary embodiment.

For convenience in explanation, it is assumed that the operation of FIG. 9 is performed by the image display apparatus 100 according to any one of exemplary embodiments of FIGS. 1, 5, and 6. Referring to FIG. 9, the image display apparatus 100 according to an exemplary embodiment displays contents on a plurality of divided display screens of the display 510 or 640 (S900).

Subsequently, the image display apparatus 100 displays voice information related to the displayed content on at least one screen except for a screen which is selected to output a voice from among the plurality of divided screens (S910).

In the above operation, when the additional information including the voice information to be displayed on at least one screen does not exist, the image display apparatus 100 replace the content with another content having the voice information and display the another content (S920). Herein, the operation of replacing a content with the another content having voice information has been described above, and thus, the detailed description thereof is omitted.

In the above operation, the image display apparatus 100 may display a message inquiring whether to change a content without additional information on a screen, and when the user accepts to change the content through the screen, may replace the content with the another content.

The above description of exemplary embodiments is provided for illustration, and it will be understood by those of ordinary skill in the art that various changes in form and details may be made therein without departing from the spirit and scope as defined by the following claims. Thus, the exemplary embodiments described therein should be considered in a descriptive sense only and not for purposes of limitation. For example, each component defined as an integration component may be implemented in a distributed fashion. Likewise, components defined as separate components may be implemented in an integrated manner.

Exemplary embodiments may also be implemented through computer-readable recording media having recorded thereon computer-executable instructions such as program modules that are executed by a computer. Computer-readable media may be any available media that can be accessed by a computer and include both volatile and nonvolatile media and both detachable and non-detachable media. Examples of the computer-readable media may include a read-only memory (ROM), a random-access memory (RAM), a compact disc (CD)-ROM, a magnetic tape, a floppy disk, an optical data storage device, etc. Furthermore, the computer-readable media may include computer storage media and communication media. The computer storage media include both volatile and nonvolatile and both detachable and non-detachable media implemented by any method or technique for storing information such as computer-readable instructions, data structures, program modules or other data. The communication media typically embody computer-readable instructions, data structures, program modules, other data of a modulated data signal such as a carrier wave, or other transmission mechanism, and they include any information transmission media.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. An image display apparatus comprising:
display configured to display a plurality of contents on a plurality of screens;
a user interface configured to receive a command for selecting a screen from among the plurality of screens;
a sound outputter configured to output a sound; and
a controller configured to control the sound outputter to output a voice of a content displayed on the selected screen, and control the display to display voice information related to at least one content among the plurality of contents, the at least one content being displayed on at least one screen among the plurality of screens.

2. The apparatus as claimed in claim 1, wherein the at least one screen where the voice information is displayed is at least one of the plurality of screens other than the selected screen.

3. The apparatus as claimed in claim 2, further comprising:
a signal receiver configured to receive an image signal corresponding to each of the plurality of contents;
a signal divider configured to divide the received image signal into a video signal, an audio signal, and additional information having voice information;
a decoder configured to decode the video signal and the audio signal;
a storage configured to store the additional information;
a video processor configured to scale the decoded video signal, add the additional information to the scaled video signal, and transmit the video signal added with the additional information to the display; and
the audio processor configured to scale and transmit the decoded audio signal to the sound outputter.

4. The apparatus as claimed in claim 3, wherein the signal receiver comprises:
a first receiver configured to receive an image signal corresponding to a content, the content comprising a broadcast signal;
a second receiver configured to receive an image signal corresponding to a content, the content not comprising the broadcast signal; and
a switching unit configured to select at least one from among the first receiver and the second receiver.

5. The apparatus as claimed in claim 4, wherein the first receiver comprises at least one tuner configured to tune at least one channel of the broadcast signal, and
wherein the second receiver comprises a plurality of input terminals configured to receive an image signal different from the broadcast signal.

6. The apparatus as claimed in claim 4, further comprising:
a graphic user interface (GUI) generator configured to generate a menu screen for displaying contents on the display to be selectable by a user, and when the additional information having voice information does not exist in a selected content, generate a message notifying nonexistence of the additional information in the selected content, and transmit the generated message to the display,
wherein the switching unit has a selection route which is controlled based on the selected content.

7. The apparatus as claimed in claim 6, wherein, when the additional information does not exist in the selected content, the GUI generator additionally generates a message inquiring whether to replace the content with another content having the additional information,
wherein, when the user instructs to replace the content with the another content, the controller controls the display to display the another content.

8. The apparatus as claimed in claim 7, wherein the controller searches the another content having the additional information.

9. The apparatus as claimed in claim 8, further comprising:
a storage configured to store history information on contents selected by the user,
wherein the controller searches the another content based on the history information.

10. The apparatus as claimed in claim 3, further comprising:
a voice transcriber configured to, when the additional information having voice information does not exist in the received image signal, analyze and transcribe a voice of a content corresponding to the received image signal;
wherein the controller displays characters generated according to a result of the analysis and transcription on the display.

11. A method for driving an image display apparatus, the method comprising:
displaying a plurality of contents on a plurality of screens trough a display;
receiving a command for selecting a screen from among the plurality of screens;
outputting a voice of a content displayed on the selected screen; and
controlling the display to display voice information related to at least one content on at least one screen among the plurality of screens.

12. The method as claimed in claim 11, wherein the at least one screen where the voice information is displayed is at least one of the plurality of screens other than the selected screen.

13. The method as claimed in claim 12, further comprising:
receiving an image signal corresponding to each of the plurality of contents;
dividing the received image signal into a video signal, an audio signal, and additional information having voice information;
decoding the video signal and the audio signal;
storing the additional information;
scaling the decoded video signal, adding the additional information to the scaled video signal, and transmitting the video signal added with the additional information to the display; and
scaling and transmitting the decoded audio signal to be output.

14. The method as claimed in claim 13, wherein the receiving the image signal comprises:
receiving, via a first route, an image signal corresponding to a content, the content comprising a broadcast signal;
receiving, via a second route, an image signal corresponding to a content, the content not comprising the broadcast signal; and
selecting at least one route from among the first route and the second route.

15. The method as claimed in claim 14, wherein the receiving the image signal corresponding to a content, the content comprising a broadcast signal, comprises tuning at least one channel of the broadcast channel, and
wherein the receiving image signal corresponding to a content, the content not comprising the broadcast signal, comprises receiving an image signal different from the broadcast signal through a plurality of input terminals.

16. The method as claimed in claim 14, further comprising:
generating a menu screen for displaying content on the display to be selectable by a user, and when the additional information having voice information does not exist in a selected content, generating and transmitting a message notifying nonexistence of the additional information in the selected content to the display,
wherein the controlling comprises controlling to select a route screen based on the selected content.

17. The method as claimed in claim 16, further comprising, when additional information does not exist in the selected content, generating a message inquiring whether to replace the content with another content having the additional information, and
wherein when a user instructs to replace the content with the another content, the controlling comprises controlling the display to display the another content.

18. The method as claimed in claim 17, wherein the controlling comprises searching r the another content having the additional information.

19. The method as claimed in claim 17, further comprising:
storing history information on contents selected by the user;
wherein the searching comprises searching the another content based on the history information.

20. The method as claimed in claim 13, further comprising:
when the additional information having voice information does not exist in the received image signal, analyzing and transcribing a voice of a content corresponding to the received image signal,
wherein the controlling comprises displaying characters generated according to a result of the analysis on the display.

21. A method for displaying an image, the method comprising:
displaying a plurality of contents on a plurality of screens on a display;
displaying voice information related to at least one content among the plurality of contents, the at least one content being displayed on at least one screen other than a screen selected to output a voice from among the plurality of screens; and
when the voice information related to the at least one content does not exist, replacing the at least one content with another content having the voice information and displaying the another content.

22. The method as claimed in claim 21, further comprising:
when the voice information related to the at least one content does not exist, displaying a message notifying nonexistence of the voice information related to the at least one content.

23. A computer readable recording medium for executing a method for displaying an image, the method comprising:
displaying a plurality of contents on a plurality of screens;
displaying voice information related to at least one content on at least one screen other than a screen selected, from among the plurality of screens, to output a voice therefrom; and
when the voice information related to the at least one content does not exist, replacing the at least one content with another content having the voice information and displaying the another content.
